(19) United States
(12) Patent Application Publication
(10) Pub. No.: US 2009/0070699 A1
(43) Pub. Date: Mar. 12, 2009

(54) Keeping Track of Progress Bar Position During an Extended Task in a Computer System

(76) Inventors: Alexis Birkill, Winchester (GB); Andrew S. M. Edwards, Southampton (GB)

Correspondence Address: Walder Intellectual Property Law PC, 17330 Preston Road, Suite 100B, Dallas, TX, 75252, US

(21) Appl. No.: 12/034,247

(22) Filed: Feb. 20, 2008

(30) Foreign Application Priority Data
Sep. 7, 2007 (EP) 07115903.2

(51) Int. Cl. G06F 3/048

(52) U.S. Cl. 715/772

(57) ABSTRACT

A marker is provided on a progress bar, to indicate the position of the progress bar when a user has, for example, clicked on the progress bar using a mouse. Therefore, for example, the user can easily see how much progress has been made since the last time the user clicked on the progress bar.

### FIELD OF THE INVENTION

The invention relates to the field of computer technology, and specifically, to a progress bar which displays, as a percentage, the amount of progress that a task has made towards the completion of the total task.

### BACKGROUND OF THE INVENTION

It is common, in computer technology environments, to display a progress bar, which indicates to the user the amount (in terms of a percentage) of progress that a task has made towards completion of the total task.

For example, if the task is the installation on a computer system of a software package, the progress provides a visual indication of the amount of progress that the computer system has made in completely installing the software package. The progress would, therefore, indicate that, for example, 15% of the task of installing the software package has been performed, and then, at a later time, the progress bar would show that more progress has been made, and now 30% of the task of installing the software package has been performed. The progress bar continues to show such progress until the task of installing the software package has been totally completed by the computer system, at which time, the progress would indicate that the task is 100% done.

Other tasks, such as the recording of a large block of data onto a disk, also make use of a progress bar.

If the machine is particularly slow, or the task is particularly intensive, the task can take several minutes, or indeed hours, to complete. Furthermore, if the stability of the machine or the reliability of the process that is running (for example, the installation of the new software package) is questionable, the system could have crashed or entered into an infinite loop.

In these situations it is often common to leave the machine running and go to do something else while the task completes, rather than the user having to watch the progress bar continually. When the user starts up a software application to do something else while he is waiting, the progress bar will usually no longer be displayed on the screen.

In such a case, the user will often go back to the progress bar to check the current status (in terms of a percentage) to see how much progress has been made since the last time the user has checked the progress bar. The problem is that the user may have forgotten what the state of the progress bar was the last time the user checked it, so when the user checks it again, the user has no indication of how much progress the task has made since the last time the user looked at the progress bar.

### SUMMARY OF THE INVENTION

The present invention provides a method as claimed in claim 1, and corresponding system and computer program. In one illustrative embodiment, the present invention provides a method of keeping track of the position of a progress bar which measures the amount of progress a computer system has made in completing a task. The method may comprise receiving, in the computer system, a first user input providing an indication to the computer system that the user would like to place a marker on the progress bar. In response to this first user input, the method may further comprise placing a marker on the progress bar. The marker provides an indication of the position of the progress bar when the user provided the first user input. The marker may be one of a line, a tick mark, an arrow, or a distinct character displayed in association with the progress bar.

The user may provide the user input by way of a mouse click. Moreover, the user may provide the user input by performing a selection of the progress bar using a user interface device. Furthermore, the first user input may be received via one of a touch screen, voice recognition, or a key press on a user interface device.

The method may further comprise updating a progress indicator of the progress bar over time. The marker may remain at a same location relative to the progress bar while the progress indicator of the progress bar is updated over time.

The method may also comprise receiving a second user input providing an indication to the computer system that the user would like to place a second marker on the progress bar.

In response to receiving the second user input, the method may comprise placing a second marker on the progress bar, the second marker providing an indication of the position of the progress bar when the user provided the second user input.

Alternatively, the method may comprise receiving a second user input providing an indication to the computer system that the user would like to update a position of the first marker on the progress bar. In response to receiving this second user input, the method may comprise placing a second marker on the progress bar in response to receiving the second user input, the second marker replacing the first marker and providing an indication of the position of the progress bar when the user provided the second user input.

The method may further provide a display of a time stamp in association with the first marker. The time stamp may identify a time of day when the first user input was received. Moreover, the method may provide a display of an elapsed time in association with the first marker. The elapsed time may be an amount of time elapsed from a time at which the first user input was received to a current time.

### BRIEF DESCRIPTION OF THE DRAWINGS

The present invention will be better understood by reading the below described description of the preferred embodiments in conjunction with the following drawings:

FIG. 1 shows a display screen showing a progress bar with a marker, according to a preferred embodiment of the present invention;

FIG. 2 shows a display screen showing a progress bar with a marker, according to a preferred embodiment of the present invention; and

FIG. 3 is a flow chart which illustrates the steps of the method according to a preferred embodiment of the present invention.

### DETAILED DESCRIPTION OF THE PREFERRED EMBODIMENTS

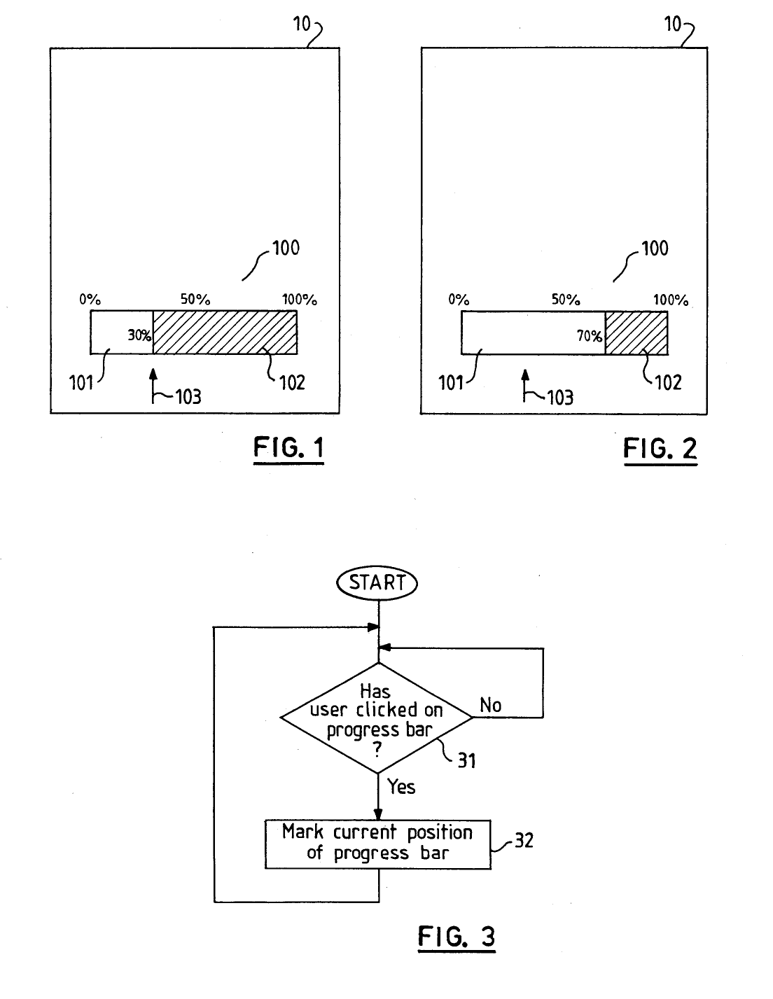

In FIG. 1, a display screen 10 of a computer is shown. A progress bar 100 is displayed on the display screen 10.

Progress bar 100 shows an indication of 0% at the far left of the progress bar 100, an indication of 50% near the middle of the progress bar 100 and an indication of 100% at the far right of the progress bar 100. This percent indication provides an indication to the user of what percent of the total task has been completed by the computer system.

For example, the task is the installation of a software component onto the computer system, and the progress measures the amount of progress the computer system has made in the total task of installing the software component onto the computer system. In the example of FIG. 1, the progress bar 100 is shown divided into two components, with a first component 101 providing a graphical indication of the amount of the task that has already been completed (30% in this example), and a second component 102 providing a graphical indication of the amount of the task that has yet to be completed (70% in this example).

The above description describes a known, prior art, progress bar.

In the preferred embodiment of the present invention, a marker 103 is inserted on the display screen, when the user, for example, clicks on the progress bar using the mouse. Then, when the user moves to another task (such as browsing to a web page to read the news) while the user is waiting for the software component to be installed, the marker 103 remains at the same position (the 30% position) even though the task of instal ling the software component continues and therefore the progress bar continues to move to higher percentages of completion.

For example, see FIG. 2 which shows that the progress bar is now indicating that 70% of the task of installing the software component is now completed, and the marker 103 is still located at the 30% position where it was in FIG. 1.

Accordingly, when the user wants to again display the progress bar (e.g., after he has read some news stories on the web using his browser), he can go back to the progress bar and then he will have a clear indication of the amount of progress that the computer system has made in completing the task of installing the software component. Specifically, the user can see, from the marker 103's position, that the progress bar used to be at the position of 30% when the user clicked on it (before the user read the news on the browser) and now, the progress bar has moved ahead from the 30% position and is now located at the 70% position.

In FIG. 3, the processing starts with a step 31 where the computer system checks whether the user has clicked on the progress bar using, for example, a mouse. If NO, control loops back to step 31 where this is checked again. If YES, control moves to step 32 where the computer system marks the current position of the progress bar, using, for example, an arrow, or other suitable marker indication, and control then loops back to step 31 (to determine whether the user has again clicked on the progress bar).

In the case when the user clicks multiple times on the progress bar, the system can either remove the original marker 103 and display only the new marker, or the system can display multiple markers showing the location of the progress bar each time the user has clicked on the progress bar.

The marker is purely some way of marking the progress bar, so, for a graphical user interface based progress bar, this marker may be a line or tickmark or arrow on or next to the progress bar. For a console based progress bar, this may be a distinct character, for example, a progress bar may use the character “#” to show how much of a task is completed and the character “.” to show how much of a task remains. A “+” character may then be used to show when the last progress marker was placed. For example,

Install progress:

#######+##### . . . 50% complete

Besides using a mouse to click on the progress bar, other user input means can also be used, such as a touch screen interface, voice recognition or a key press.

A time stamp can also be placed adjacent to the marker 103 to indicate the time of day when the user provided an indication that the user would like to place the marker 103 on the progress bar. This would then provide further information to the user when the user returns to the progress bar. Alternatively, the time that has elapsed since the user has provided the indication could be displayed (so, for example, “5 minutes” could be displayed to thereby indicate that 5 minutes has elapsed since the user last provided the indication).

1. A method of keeping track of the position of a progress bar which measures the amount of progress a computer system has made in completing a task, comprising of:
receiving, in the computer system, a first user input providing an indication to the computer system that the user would like to place a marker on the progress bar; and
placing a marker on the progress bar in response to receiving the first user input wherein the marker provides an indication of the position of the progress bar when the user provided the first user input.

2. The method of claim 1 wherein the user provides the user input by a mouse click.

3-4. (canceled)

5. The method of claim 1, wherein the user provides the user input by performing a selection of the progress bar using a user interface device.

6. The method of claim 1, further comprising:
updating a progress indicator of the progress bar over time, wherein the marker remains at a same location relative to the progress bar while the progress indicator of the progress bar is updated over time.

7. The method of claim 1, further comprising:
receiving a second user input providing an indication to the computer system that the user would like to place a second marker on the progress bar; and
placing a second marker on the progress bar in response to receiving the second user input, wherein the second marker provides an indication of the position of the progress bar when the user provided the second user input.

8. The method of claim 1, further comprising:
receiving a second user input providing an indication to the computer system that the user would like to update a position of the first marker on the progress bar; and
placing a second marker on the progress bar in response to receiving the second user input, wherein the second marker replaces the first marker and provides an indication of the position of the progress bar when the user provided the second user input.

9. The method of claim 1, further comprising:
providing a display of a time stamp in association with the first marker, wherein the time stamp identifies a time of day when the first user input was received.

10. The method of claim 1, further comprising:
providing a display of an elapsed time in association with the first marker, wherein the elapsed time is an amount of time elapsed from a time at which the first user input was received to a current time.

11. The method of claim 1, wherein the first user input is received via one of a touch screen, voice recognition, or a key press on a user interface device.

12. The method of claim 1, wherein the marker is one of a line, a tick mark, an arrow, or a distinct character displayed in association with the progress bar.

13. A computer program product comprising a computer program stored on a computer readable medium which, when executed on a computer system, causes the computer system to:
receive, in the computer system, a first user input providing an indication to the computer system that the user would like to place a marker on the progress bar; and
place a marker on the progress bar in response to receiving the first user input, wherein the marker provides an indication of the position of the progress bar when the user provided the first user input.

14. The computer program product of claim 13, wherein the user provides the user input by performing a selection of the progress bar using a user interface device.

15. The computer program product of claim 13, wherein the computer readable program further causes the computing system to:
update a progress indicator of the progress bar over time, wherein the marker remains at a same location relative to the progress bar while the progress indicator of the progress bar is updated over time.

16. The computer program product of claim 13, wherein the computer readable program further causes the computing system to:
receive a second user input providing an indication to the computer system that the user would like to place a second marker on the progress bar; and
place a second marker on the progress bar in response to receiving the second user input, wherein the second marker provides an indication of the position of the progress bar when the user provided the second user input.

17. The computer program product of claim 13, wherein the computer readable program further causes the computing system to:
receive a second user input providing an indication to the computer system that the user would like to update a position of the first marker on the progress bar; and
place a second marker on the progress bar in response to receiving the second user input, wherein the second marker replaces the first marker and provides an indication of the position of the progress bar when the user provided the second user input.

18. The computer program product of claim 13, wherein the computer readable program further causes the computing system to:
provide a display of a time stamp in association with the first marker, wherein the time stamp identifies a time of day when the first user input was received.

19. The computer program product of claim 13, wherein the computer readable program further causes the computing system to:
provide a display of an elapsed time in association with the first marker, wherein the elapsed time is an amount of time elapsed from a time at which the first user input was received to a current time.

20. The computer program product of claim 13, wherein the first user input is received via one of a touch screen, voice recognition, or a key press on a user interface device.

21. The computer program product of claim 13, wherein the marker is one of a line, a tick mark, an arrow, or a distinct character displayed in association with the progress bar.

22. A computer system, comprising:
a processor; and
a display screen coupled to the processor, wherein the display screen displays a progress bar, and wherein the processor:
receives, from a user input device, a first user input providing an indication to the computer system that the user would like to place a marker on the progress bar; and
places a marker on the display of the progress bar in response to receiving the first user input, wherein the marker provides an indication of the position of the progress bar when the user provided the first user input.
